(19) United States
(12) Patent Application Publication
(10) Pub. No.: US 2019/0366588 A1
(43) Pub. Date: Dec. 5, 2019

(54) COMPOSITE AND METHOD FOR MANUFACTURING SAME

(71) Applicants: SHENZHEN FUTAIHONG PRECISION INDUSTRY CO., LTD., Shenzhen (CN); FIH (HONG KONG) LIMITED, Kowloon (HK)

(72) Inventors: CHWAN-HWA CHIANG, New Taipei (TW); CHEN-YI TAI, New Taipei (TW); ZENG-MAO ZHENG, Shenzhen (CN)

(21) Appl. No.: 16/284,021

(22) Filed: Feb. 25, 2019

(30) Foreign Application Priority Data
May 31, 2018 (CN) 201810553611.7

(51) Int. Cl. B29B 11/14; B29C 45/14; C23G 5/032; C23G 1/02; C22F 1/18; C22F 1/08; C22F 1/11; C21D 10/00

(52) U.S. Cl. CPC B29B 11/14; B29C 45/14795; B29C 45/14377; C23G 5/032; B82Y 30/00; C22F 1/183; C22F 1/08; C22F 1/11; C21D 10/00; C23G 1/02

(57) ABSTRACT

A composite object with more complete and stronger adhesion between the constituent parts includes a substrate and a plastic member formed on a surface of the substrate. The substrate can be made of memory metal. Nano-holes are formed on the surface of the substrate. The composite further includes a combining layer. The combining layer is positioned between the substrate and the plastic member. The nano-holes are at least partially filled with the combining layer, unfilled holes being filled with the plastic constituent in the molten state. The disclosure further provides a method for manufacturing the composite.

### FIELD

The subject matter herein generally relates to a composite object.

### BACKGROUND

Metal and plastic composites on the market are generally aluminum, stainless steel and other materials combined with plastics by nano-molding technology. Nano-molding technology can't be usefully applied to memory alloys.

### BRIEF DESCRIPTION OF THE DRAWINGS

Embodiments of the present disclosure will now be described, with reference to the attached figures.

FIG. 1 is a schematic cross sectional view of an embodiment of a composite.

FIG. 2 is a cross-sectional view of a portion of the composite shown in FIG. 1.

FIG. 3 is a flow chart of a method for making a composite in accordance with an embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures, and components have not been described in detail so as not to obscure the related relevant feature being described. Further, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

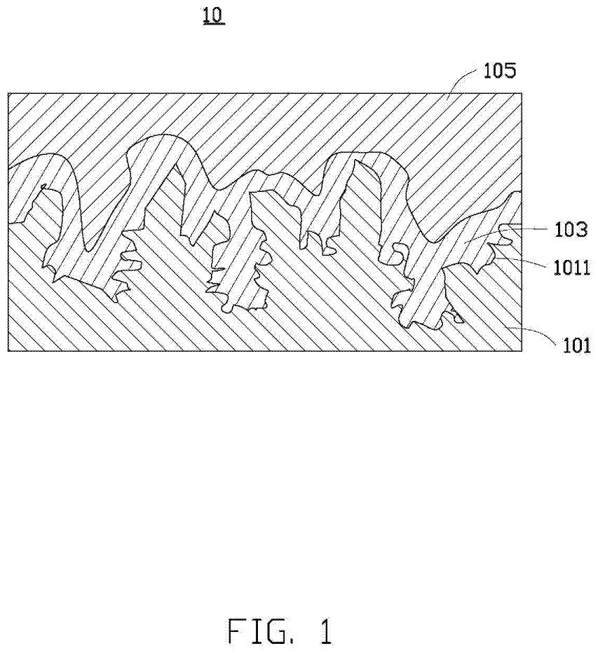

FIG. 1 illustrates an embodiment of a composite 10.

The composite 10 includes a substrate 101, a combining layer 103, and a plastic member 105.

The substrate 101 is made of a memory metal. The memory metal can be selected from a group consisting of Ti—Ni based memory alloys, Cu-based memory alloy, Fe-based memory alloy, and Au—Cr alloys. The Ti—Ni based memory alloys can be selected from a group consisting of Ti—Ni alloys, Ti—Ni—Nb alloys, and Ti—Ni—Pb alloys. The Cu-based memory alloy can be selected from a group consisting of Cu—Au—Zn alloys, Cu—Al alloys, and Cu—Sn alloys. The Fe-based memory alloy can be selected from one of Fe—Pb alloys and Fe—Mn—Si alloys.

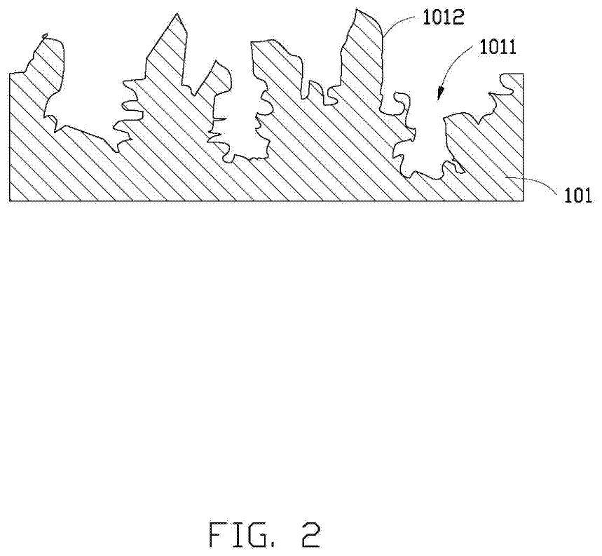

Referring to FIG. 2, the substrate 101 has nano-holes 1011 formed on a surface of the substrate 101. The nano-holes 1011 are irregular cavities, and widths of the nano-holes 1011 vary in a range from several tens of nanometers to several hundreds of nanometers. Shapes of the nano-holes 1011 are substantially similar to honeycombs.

Referring to FIG. 2, irregular protrusions 1012 accompany the nano-holes 1011. The protrusions 1012 are formed beside the nano-holes 1011, or inside the nano-holes 1011. The protrusions 1012 are portions of the substrate 101. In another embodiment, the protrusions 1012 can be formed at portions of the substrate 101 other than the nano-holes 1011 and the protrusions 1012.

In present embodiment, the nano-holes 1011 and the protrusions 1012 are formed on the substrate 101 by treating with acid. Specifically, the substrate 101 is immersed in a pickling solution at 15-95° C. for 2-30 minutes. The pickling solution includes 5-15% by weight of organic acids, 1-19% by weight of inorganic acids, 0.3-5.5% by weight of additives, 0.1-5% by weight of hydrogen peroxide, and 75-93% by weight of pure water. The organic acid is one or more of formic acid, acetic acid, oxalic acid, and citric acid. The inorganic acid is one or more of hydrofluoric acid, sulfamic acid, nitric acid, sulfuric acid, and hydrochloric acid. The additive is one or more of potassium fluoride, polyethylene glycol, sodium fluoride, magnesium fluoride, copper sulfate, and glycerin.

The combining layer 103 is formed on the surface of the acid treated substrate 101. The surface of the substrate 101 includes the surface of the nano-holes 1011 and the surface of the protrusions 1012. Specifically, the substrate 101 is put into a surface treating agent, and reacted for 0.1-3 minutes to form the combining layer 103 on the surface of the substrate 101. In present embodiment, the nano-holes 1011 are partially filled with the surface treating agent. The surface treating agent can be selected from a group consisting of alcohol amine reagents, nitroalkane reagents, alcohol amine reagents, and nitroalkane reagents.

The plastic member 105 is formed on the combining layer 103 by injection molding process. In present embodiment, portions of the nano-holes 1011 which are not filled with the combining layer 103 are filled with the plastic member 105. The plastic member 105 is crystalline thermoplastic. The crystalline thermoplastic can be polyamide, polyphenylene sulfide, polybutylene terephthalate, polycarbonate, polyvinyl chloride, or other common nano injection molding plastics.

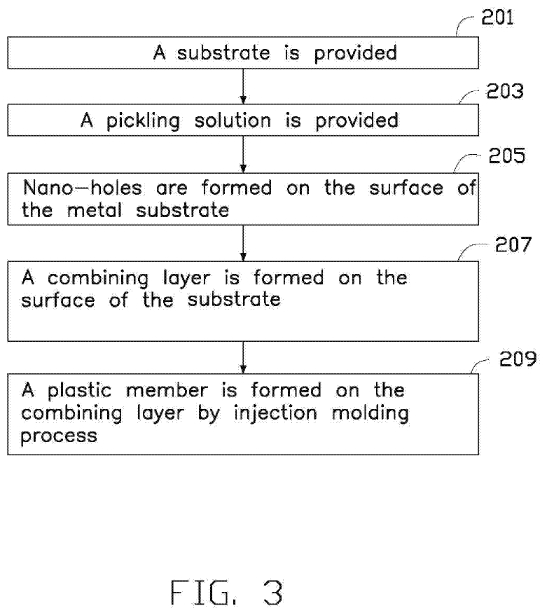

Referring to FIG. 3, a method for manufacturing the composite 10 as follows:

At block 201, a substrate 101 is provided. The substrate 101 is made of a memory metal. The memory metal can be selected from a group consisting of Ti—Ni based memory alloys, Cu-based memory alloy, Fe-based memory alloy, and Au—Cr alloys. The Ti—Ni based memory alloys can be selected from a group consisting of Ti—Ni alloys, Ti—Ni—Nb alloys, and Ti—Ni—Pb alloys. The Cu-based memory alloy can be selected from a group consisting of Cu—Au—Zn alloys, Cu—Al alloys, and Cu—Sn alloys. The Fe-based memory alloy can be selected from one of Fe—Pb alloys or Fe—Mn—Si alloys

The substrate 101 is cleaned. In present embodiment, the cleaning process includes dipping the substrate 101 in a degreasing solution, and then removing the substrate 101 from the degreasing solution and rinsing with pure water to remove dust and oil on the surface of the substrate 101.

At block 203, a pickling solution is provided. In present embodiment, the pickling solution includes 5-15% by weight of organic acids, 1-19% by weight of inorganic acids, 0.3-5.5% by weight of additives, 0.1-5% by weight of hydrogen peroxide, and 75-93% by weight of pure water. The organic acid is one or more of formic acid, acetic acid, oxalic acid, and citric acid. The inorganic acid is one or more of hydrofluoric acid, sulfamic acid, nitric acid, sulfuric acid, and hydrochloric acid. The additive is one or more of potassium fluoride, polyethylene glycol, sodium fluoride, magnesium fluoride, copper sulfate, and glycerin.

At block 205, nano-holes 1011 are formed on the surface of the substrate 101. Specifically, immersing the substrate 101 into the pickling solution, and pickling it at 15-95° C. for 2-30 minutes to form a plurality of nano-holes 1011 on the surface of the substrate 101. The nano-hole 1011 are irregular cavities, widths of the nano-holes 1011 vary in a range from several tens to several hundreds of nanometers. Shapes of the nano-holes 1011 are substantially similar to honeycombs.

Further, protrusions 1012 are formed accompanied with the nano-holes 1011. The protrusions 1012 are irregular. The protrusions 1012 can be formed beside the nano-holes 1011, or be formed inside the nano-holes 1011 or be formed at any other parts of the substrate 101. The protrusions 1012 belong to a portion of the substrate 101.

After pickling, the substrate 101 having the nano-holes 1011 and the protrusions 1012 is washed. Specifically, rinsing the surface of the substrate 101 with pure water to remove the pickling solution on the surface of the substrate 101.

At block 207, a combining layer 103 is formed on the surface of the substrate 101 having the nano-holes 1011.

Specifically, putting the substrate 101 into a surface treating agent, and reacting for 0.1-3 minutes to form the combining layer 103 on the surface of the substrate 101. In present embodiment, the nano-holes 1011 are partially filled with the surface treating agent. The surface treating agent can be selected from one of alcohol amine reagents, nitroalkane reagents, alcohol amine reagents, and nitroalkane reagents.

The substrate 101 having the combining layer 103 is washed again.

Specifically, rinsing the surface of the substrate 101 and the combing layer 103 with pure water to remove the surface treating agent on the surface of the substrate 101 and the combining layer 103.

At block 209, a plastic member 105 is formed on the combining layer 103 by injection molding process. In present embodiment, the injection molding process includes steps of, first, putting the substrate 101 with the combining layer 103 in an injection molding mold. Second, injecting molten nano injection molding plastic into the injection molding mold, so that the nano injection molding plastic covers the surface of the combining layer 103. Harden the plastic member 105 to obtain the composite 10 in which the substrate 101 and the plastic member 105 are combined. The plastic member 105 is crystalline thermoplastic. The crystalline thermoplastic can be polyamide, polyphenylene sulfide, polybutylene terephthalate, polycarbonate, polyvinyl chloride, or other common nano injection molding plastics.

In present embodiment, the portion of the nano-holes 1011 that is not filled with the combining layer 103 is filled with the plastic member 105 to enhance the bonding force between the plastic member 105 and the substrate 101. The surface treating agent utilized for the combining layer 103 can be chosen according to the plastic member 105 to produce greater chemical bonding force. The chemical bonding force further enhances the adhesion of the plastic member 105 to the substrate 101.

Different embodiments of the present disclosure are described.

### Embodiment 1

The substrate 101 is made of Ti—Ni alloys, titanium and nickel accounting for 50% each in Ti—Ni alloys.

The substrate 101 is cleaned. Dipping the substrate 101 in a degreasing solution for 2 minutes at 50° C. Then, the substrate 101 is removed from the degreasing solution and rinsed with water to remove dust and oil on the surface of the substrate 101.

A pickling solution is provided. The pickling solution includes 4% by weight of sulfuric acid, 2% by weight of nitric acid, 7% by weight of formic acid, 1.2% by weight of additive, 2% by weight of hydrogen peroxide, and 83.8% by weight of pure water.

Nano-holes 1011 are formed on the surface of the substrate 101. Specifically, putting the substrate 101 into the pickling solution, and pickling the substrate 101 at 25° C. for 15 minutes to form a plurality of nano-holes 1011 on the surface of the substrate 101.

The substrate 101 is washed. Specifically, rinsing the surface of the substrate 101 with pure water to remove the pickling solution attached to the surface of the substrate 101.

A combining layer 103 is formed on the surface of the substrate 101 having the nano-holes 1011 by surface treatment. Specifically, putting the substrate 101 into a surface treating agent, and reacting for 3 minutes to form the combining layer 103 on the surface of the substrate 101. In present embodiment, the nano-holes 1011 are partially filled with the surface treating agent. The surface treating agent is alcohol amine reagents and nitroalkane reagents.

The substrate 101 is washed again. Specifically, rinsing the surface of the substrate 101 with pure water to remove the surface treating agent on the surface of the substrate 101.

A plastic member 105 is formed on the combining layer 103 by injection molding process. In present embodiment, the injection molding process includes steps of, first, putting the substrate 101 having the combining layer 103 in an injection molding mold. Second, injecting molten polyphenylene sulfide resin into the injection molding mold, so that the polyphenylene sulfide resin covers the surface of the combining layer 103. Harden the plastic member 105 to obtain the composite 10 in which the substrate 101 and the plastic member 105 are combined. In present embodiment, the portion of the nano-holes 1011 that is not filled with the combining layer 103 is filled with the polyphenylene sulfide resin.

Test Results:

Tensile test: The composite 10 was tested using a universal material testing machine, and the combined strength of 0.5 cm² area was 1200-1500 N.

### Embodiment 2

The substrate 101 is made of Ti—Ni alloys. Titanium and nickel account for 50% each in Ti—Ni alloys.

The substrate 101 is cleaned. Dipping the substrate 101 in a degreasing solution for 2 minutes at 50° C. Then, the substrate 101 is removed from the degreasing solution and rinsed with water to remove dust and oil stains covered on the surface of the substrate 101.

A pickling solution is provided. The pickling solution includes 5% by weight of sulfuric acid, 3% by weight of nitric acid, 3% by weight of acetic acid, 4.5% by weight of oxalic acid, 2.3% by weight of additive, 1% by weight of hydrogen peroxide, and 81.2% by weight of pure water.

Nano-holes 1011 are formed on the surface of the substrate 101. Specifically, putting the substrate 101 into the pickling solution, and pickling the substrate 101 at room temperature for 10 minutes to form a plurality of nano-holes 1011 on the surface of the substrate 101.

The substrate 101 is washed. Specifically, rinsing the surface of the substrate 101 with pure water to remove the pickling solution attached to the surface of the substrate 101.

A combining layer 103 is formed on the surface of the substrate 101 having the nano-holes 1011 by surface treatment. Specifically, putting the substrate 101 into a surface treating agent, and reacting for 2 minutes to form the combining layer 103 on the surface of the substrate 101. In present embodiment, the nano-holes 1011 are partially filled with the surface treating agent. The treating agent is alcohol amine reagents and nitroalkane reagents.

The substrate 101 is washed again. Specifically, rinsing the surface of the substrate 101 with pure water to remove the surface treating agent on the surface of the substrate 101.

A plastic member 105 is formed on combining 103 by injection molding process. In present embodiment, the injection molding process includes steps of, first, putting the substrate 101 having the combining layer 103 in an injection molding mold. Second, injecting molten polyamide resin into the injection molding mold, so that the polyamide resin covers the surface of the combining layer 103. Harden the plastic member 105 to obtain the composite 10 in which the substrate 101 and the plastic member 105 are combined. In present embodiment, the portion of the nano-holes 1011 that is not filled with the combining layer 103 is filled with the polyamide resin.

Test Results:

Tensile test: The composite 10 was tested using a universal material testing machine, and the combined strength of 0.5 cm² area was 1150-1500 N.

The composite 10 has an increased bonding force between the substrate 101 and the plastic member 105 because of the nano-holes 1011 on the surface of the substrate 101. The combining layer 103 is also formed between the substrate 101 and the plastic member 105 to further enhance the interbonding force. The nano-holes 1011 are at least partially filled with the combining layer 103, a portion of the nano-holes 1011 that is not filled with the combining layer 103 is filled with the plastic member 105. At the same time, the operation processes of this case are simple. In addition, the preparation of the composite 10 does not need to be implemented in a high temperature environment, and the safety of the operation is also improved.

It is to be understood, however, that even through numerous characteristics and advantages of the present disclosure have been set forth in the foregoing description, together with details of assembly and function, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A composite comprising:
a substrate made of a memory metal, the substrate comprising nano-holes on a surface of the substrate;
a combining layer on the substrate, the nano-holes being partially filled with the combining layer; and
a plastic member on the combining layer.

2. The composite of claim 1, wherein the nano-holes are irregular cavities, and widths of the nano-holes vary in a range from several tens of nanometers to several hundreds of nanometers.

3. The composite of claim 2, wherein shapes of the nano-holes are substantially similar to honeycombs, and the nano-holes are surrounded by irregular protrusions.

4. The composite of claim 1, wherein the memory metal is selected from Ti—Ni based memory alloys, Cu-based memory alloy, Fe-based memory alloy and Au—Cr alloys.

5. The composite of claim 1, wherein portions of the nano-holes that is not filled with the combining layer is filled with the plastic member.

6. The composite of claim 1, wherein the combining layer is made of alcohol amine reagents and nitroalkane reagents.

7. A method for manufacturing a composite comprising:
providing a substrate made of a memory metal;
forming nano-holes on a surface of the substrate by acid treatment;
forming a combining layer on the substrate by surface treatment of the surface of the substrate, and partially filling the nano-holes with the combining layer; and
forming a plastic member on the combining layer.

8. The method of claim 7, the acid treatment comprises pickling the surface of the substrate with a pickling solution, wherein the pickling solution comprises 5-15% by weight of organic acids, 1-19% by weight of inorganic acids, 0.3-5.5% by weight of additives, 0.1-5% by weight of hydrogen peroxide, and 75-93% by weight of pure water.

9. The method of claim 8, wherein the organic acid is one or more of formic acid, acetic acid, oxalic acid, and citric acid; the inorganic acid is one or more of hydrofluoric acid, sulfamic acid, nitric acid, sulfuric acid, and hydrochloric acid; and the additive is one or more of potassium fluoride, polyethylene glycol, sodium fluoride, magnesium fluoride, copper sulfate, and glycerin.

10. The method of claim 7, the surface treatment comprises immersing the substrate having the nano-holes with a surface treating agent for 0.1 to 3 minutes, partially filling the nano-holes with the surface treating agent; and forming the combining layer on the surface of the substrate.

11. The method of claim 10, wherein the surface treating agent is alcohol amine reagents and nitroalkane reagents.

12. The method of claim 7, wherein the nano-holes are irregular cavities, and widths of the nano-holes vary in a range from several tens of nanometers to several hundreds of nanometers.

13. The method of claim 7, wherein shapes of the nano-holes are substantially similar to honeycombs, and the nano-holes are surrounded by irregular protrusions.

14. The method of claim 7, wherein the memory metal is selected from Ti—Ni based memory alloys, Cu-based memory alloy, Fe-based memory alloy and Au—Cr alloys.
